(19) United States
(12) Patent Application Publication
(10) Pub. No.: US 2002/0062246 A1
(43) Pub. Date: May 23, 2002

(54) Advertising information transmitting and receiving methods

(76) Inventor: Hajime Matsubara, Kawasaki (JP)

Correspondence Address: STAAS & HALSEY LLP, 700 11TH STREET, NW, SUITE 500, WASHINGTON, DC, 20001, US

(21) Appl. No.: 09/805,157

(22) Filed: Mar. 14, 2001

(30) Foreign Application Priority Data
Nov. 21, 2000 (JP) 2000-354249

(51) Int. Cl. G06F 17/60

(52) U.S. Cl. 705/14; 701/213

(57) ABSTRACT

Passage-count-dependent advertising information is transmitted to a client vehicle by receiving position information from a client, determining the passage count of the client in a predetermined advertising information transmission area in which the position information belongs and storing it, and transmitting to the client advertising information according to the passage count of the client in the transmission area.

### BACKGROUND OF THE INVENTION

1. Field of the Invention

The present invention relates to advertising information transmitting and receiving methods and more specifically to advertising information transmitting and receiving methods to transmit and receive advertising information according to the number of times a vehicle has passed through an area.

2. Description of the Related Art

With the development of so-called car navigation systems, the current position of a car can be detected very accurately and displayed superimposed on a map on a display screen. A service has also been performed which provides car drivers with traffic information in areas through which they are now passing.

Business enterprises, such as gas stations, restaurants, etc., that consider car drivers (including fellow passengers) as users aim to attract the users as customers (repeaters) like other enterprises do. With such industry, however, the aim is generally considered difficult to attain.

The indication to car drivers of not only traffic information but also advertising information for stores in areas through which they are passing on a display screen together with a map is expected to be useful in attracting customers. Further, it is expected that those who frequently pass through the neighborhood of the stores will actually use the stores as a result of watching such advertising information. That is, the probability of car drivers using the stores will be proportional to the number of times they pass by the stores (hereinafter referred sometimes to as the passage count). Transmitting to car drivers such advertising information as allows their profit to increase with increasing passage count is expected to be very useful in attracting customers. Also, transmitting to car drivers such advertising information (incentive information) as offers an incentive to them which increases with increasing passage count is expected to be very useful in attracting customers. On the other hand, if the advertising information and the incentive information are what depends on only the passage count, the information will have no appeal for drivers who little pass, which causes disadvantages in attracting customers.

### BRIEF SUMMARY OF THE INVENTION

It is an object of the present invention to provide an advertising information transmitting method which permits advertising information according to the passage count to be transmitted to a client which is a vehicle.

It is another object of the present invention to provide an advertising information transmitting method which permits incentive information distinct from advertising information to be transmitted to a client.

It is still another object of the present invention to provide an advertising information receiver method which permits a client to receive advertising information according to the passage count.

According to a first aspect of the present invention there is provided a method transmitting advertising information, comprising: receiving position information from a client; determining a passage count of the client in a predetermined advertising information transmission area in which the position information belongs and storing the passage count; and transmitting to the client advertising information according to the passage count of the client in the transmission area.

According to a second aspect of the present invention there is provided a method transmitting advertising information, comprising: setting up conditions assigning incentive information distinct from the advertising information in a predetermined advertising information transmission area; receiving position information from a number of clients; determining the state of passage of each of the clients in the transmission area in which the position information from the clients belong; and assigning the incentive information to the client or clients that meet the conditions on the basis of the state of passage.

According to a third aspect of the present invention there is provided a method receiving advertising information, comprising: transmitting position information of a client sequentially to a server; receiving from the server advertising information according to the count of passage through that transmission area at that time, when passing through an advertising information transmission area in which the position information belongs.

According to a fourth aspect of the present invention there is provided a method receiving advertising information, comprising: transmitting position information of a client sequentially to a server; transmitting a request for transfer to the server; receiving the count of passage through a transmission area for the advertising information at the time of transmission of the transfer request or corresponding incentive information to the passage count; and storing the received passage count or incentive information on a portable external storage medium.

According to a fifth aspect of the present invention there is provided a method receiving advertising information, comprising: receiving a transmission area management database which defines transmission areas for advertising information; retrieving from the database a count of passage through the transmission area through which it is passing based on position information of a client, and storing the count passage; transmitting to the server a request for transmission of advertising information and the passage count; and receiving from the server advertising information according to the passage count in the transmission area at time of the transmitting.

### BRIEF DESCRIPTION OF THE DRAWINGS

The present invention will become more apparent from the following description of the preferred embodiments with reference to the accompanying drawings, in which:

FIG. 1 is a schematic illustration of an advertising information transmitting system;

FIG. 2 is a conceptual diagram of a specific arrangement of the advertising information transmitting system;

FIG. 3 shows the arrangement of an advertising information transmitting server;

FIG. 3B shows the arrangement of a client;

FIG. 4 is a flowchart for the advertising information transmission processing carried out in the advertising information transmitting system;

FIG. 5A is a flowchart for the advertising information transmitting condition setup processing and the passage count update processing carried out by the advertising information transmitting server;

FIG. 5B is a flowchart for the advertising information transmission processing carried out by the advertising information transmitting server;

FIG. 5C is a flowchart for the incentive information utilization processing carried out by the advertising information transmitting server;

FIGS. 6A, 6B, 6C, 6D and 6E show transmission area management databases;

FIGS. 7A, 7B, 7C and 7D are diagrams for use in explanation of transmission of advertising information;

FIG. 8 shows one example of the advertising information database;

FIGS. 9A, 9B and 9C shows examples of advertising information outputting forms; and

FIGS. 10, 11 and 12 are schematic illustrations of other advertising information transmission systems.

### DETAILED DESCRIPTION OF THE INVENTION

Reference will now be made in detail to the preferred embodiments of the present invention, examples of which are illustrated in the accompanying drawings.

An advertising information transmitting method of the present invention involves receiving the position information of a client (vehicle), determining the number of times the client has passed through a transmission area (coverage area) for predetermined advertising information in which the current position of the client belongs, and transmitting to the client advertising information according to its count of passage through that transmission area.

The advertising information transmitting method of the present invention can provide a client which is passing through an area with advertising information concerning a store in that area, thus allowing customers to be attracted in an efficient manner. It is also possible to transmit to a car driver who frequently passes by the store such advertising information as may allow his or her profit to increase with increasing passage count or such incentive information as promotes the use of the store. From this point of view as well, customers can be attracted in an efficient manner.

Moreover, another advertising information transmitting method of the present invention involves setting up conditions for incentive information distinct from advertising information, determining the count of passage through a transmission area for predetermined advertising information for each of two or more clients by receiving their current position information, and transmitting the incentive information to a client or clients that satisfy the conditions.

The advertising information transmitting method of the present invention can provide a client with incentive information besides advertising information according to passage count independent conditions (for example, the conditions are set up such that the incentive information is given to the tenth client to pass through the area). Therefore, not only drivers who have high passage count but also drivers who have relatively low passage count can be attracted in an efficient manner.

Furthermore, still another advertising information transmitting method of the present invention involves transmitting the position information of a client to a server sequentially, transmitting to the server a request to transmit advertising information, and receiving passage count dependent advertising information for a transmission area through which the client is passing.

According to the advertising information transmitting method of the present invention, when passing through a transmission area the client can receive advertising information which is dependent on the number of times so far the client has passed through that area. Therefore, the client is allowed to receive more profitable advertising information or incentive information in a transmission area through which the client frequently passes to go to his or her office or factory by way of example.

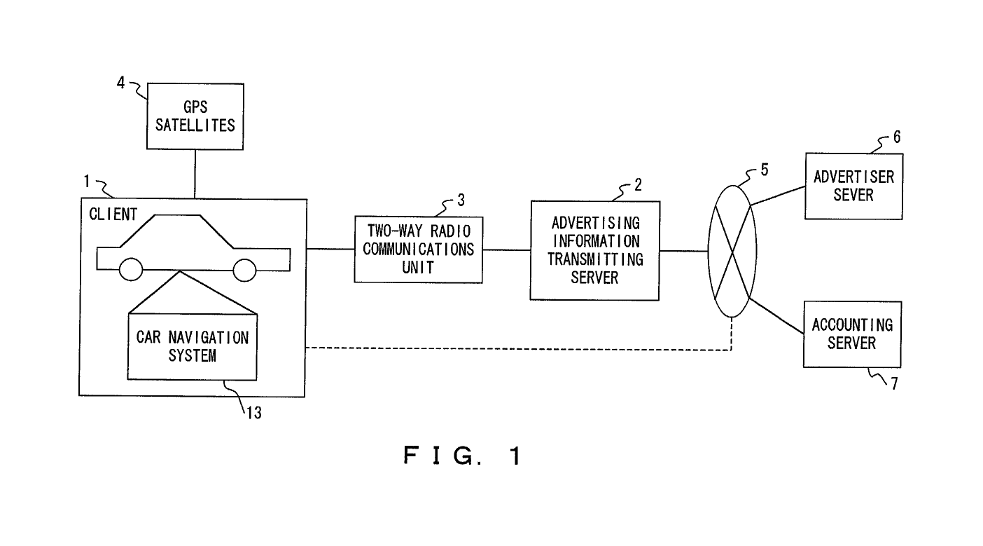

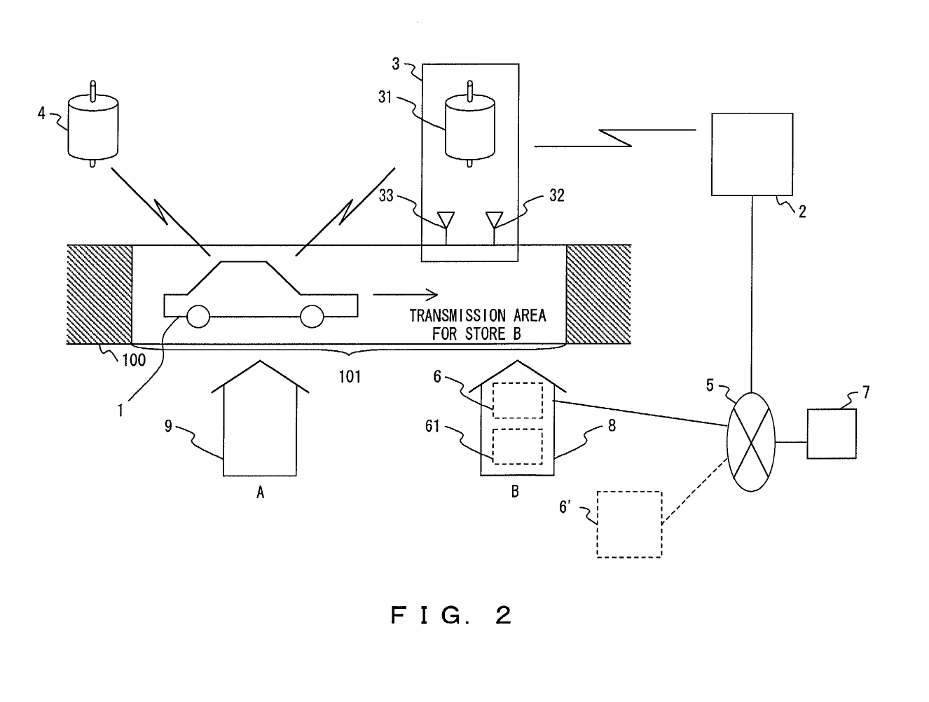

FIGS. 1 and 2 shows schematically the configuration of an advertising information transmission system of the present invention. Particularly, FIG. 1 is a schematic illustration of the advertising information transmission system and FIG. 2 conceptually illustrates the specific configuration of the system.

A client 1 is equipped with a car navigation system 13 that contains map information stored on a CD-ROM as an example. The client 1, while running on a road 100 on which a transmission area 101 (the other area than the shaded area in FIG. 2) is set up, obtains its position information via signals from GPS (Global Positioning Systems) satellites 4 sequentially. Using the position information, the client's position is displayed on a map on a screen associated with the car navigation system as is well known.

The client 1 is connected with an advertising information transmitting server 2 by a two-way radio communications unit 3 so that communications are made between them. That is, the client 1 transmits its position information sequentially to the server 2 with which a contract has been made to receive an advertising information transmitting service and transmits a request to transmit advertising information.

The server 2, upon receipt of the position information from the client 1, calculates the number of times the client 1 has passed the transmission area 101 allocated to an advertiser server 6 with which a contract has been made. The server 2 transmits advertising information to the client 1 accordingly. That is, in response to the position information of the client 1, the server 2 transmits to the client 1 advertising information of the advertiser server 6 with which a contract has been made to transmit advertising information to the transmission area 101. That is, when the client 1 is inside the contract area of a B store (store 8), advertising information for that store is transmitted. Suppose here that an A store 9 of the same business exists before the B store 8 along the same road 100. In that case, it can be expected that the driver of the client 1 will drop into the B store as a result of watching the B's advertising information.

As will be described in detail later, the contents of the advertising information transmitted from the server 2 are set up according to the client's count of passage through the transmission area 101 for the B store (or the number of points based on the passage count). The advertising information contains incentive information (e.g., discount, etc.) to use the advertiser server 6 which transmitted the advertising information and has contracted with the advertising information transmitting server 2. For example, in the case of the first passage, advertising information is merely to the effect that there is the B store. In the case of the tenth passage, such advertising information is followed by incentive information to the effect that we will make discount.

The two-way radiocommunications unit 3 may be any equipment that enables the client 1 to make radiocommunications while moving, such as a communications satellite 31, a communications terminal 32 installed along the road 100 for the so-called intelligent transport systems (ITS), an antenna 33 for mobile communications, or the like. Instead of the communications satellite 31, the GPS satellites 4 may be used as the two-way radiocommunications unit. The client 1, even though not having the two-way radiocommunications function by itself, may make communications with the advertising information transmitting server 2 over the Internet (network 5) as shown by dashed line in FIG. 1 through the use of an Internet-connectable (so-called i mode) cellular phone. Where the communications satellite 31 or a cellular phone is used, the advertising information transmitting server 2 may be installed in one place. However, this is not restrictive. An area may be subdivided into subareas and an advertising information transmitting server 2 may be installed in each subarea.

The advertising information transmitting server 2 is connected through the network 5, such as the Internet, with the advertiser server 6 installed in the store 8, such as a gas station, which is an advertiser which is used by the client 1. That is, the advertiser server 6 sends to the advertising information transmitting server 2 a request to identify the client 1 and determine if the client 1 has been assigned incentive information for the use of the store 8. Also, the advertiser server sends a notification of the completion of use of the incentive by the client 1.

Upon receipt of the request from the server 6, the advertising information transmitting server 2 sends as a response the presence or absence of incentive information for the client 1 and its contents to the advertiser server 6. Upon receipt of the completion notification from the server 6, the advertising information transmitting server 2 updates the passage count and the incentive information for the client 1.

An accounting server 7 installed in a credit company may be connected through the network 5 with the advertising information transmitting server 2 and the advertiser server 6. That is, the accounting server 7, upon receiving a request made by the server 2 and/or the server 6 to settle an account with the client 1, bills the client 1.

In the example of FIG. 2, one advertiser server 6 is installed in one store 8, enters advertising information into the advertising information transmitting server 2, requests the server 2 to transmit the advertising information, and allows the client 1 to utilize incentive information. However, there may exist a number of stores in the same enterprise group like convenience stores. In this case, as shown by dashed lines in FIG. 2, one advertiser server 6′ installed in the main office may enter advertising information into the advertising information transmitting server 2 and a terminal 61 (computer) installed in each store may transmit incentive information. Thus, the computer that enters advertising information and the computer that transmits a request for confirmation of utilization of incentive information and a notification of completion of the utilization may be separate units. That is, the latter computer is not restricted to the advertiser server 6′ but may be the terminal 61 installed in each store. In such a case, the advertiser server 6′ and the terminal 61 make communications with each other over the network 5. The two or more stores 8 maybe located in the same transmission area or in different transmission areas. Different advertising information may be transmitted for each of stores located in different transmission areas.

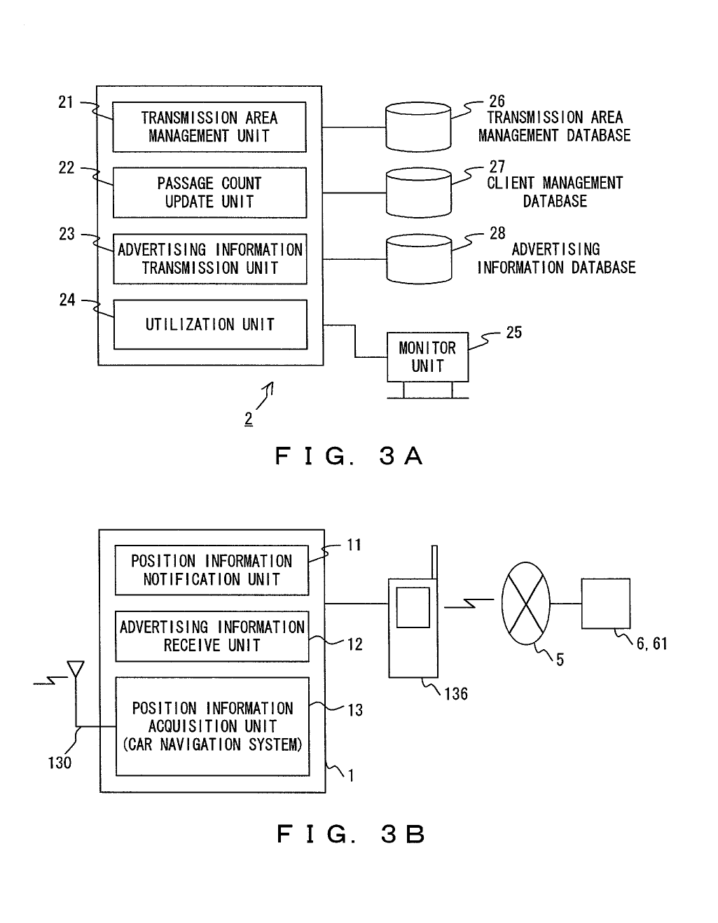

FIG. 3A shows the arrangement of the advertising information transmitting server 2.

The server 2 includes a transmission area management unit 21, a passage count update unit 22, an advertising information transmitting unit 23, and a utilization unit 24, which are implemented by executing programs resident in main storage (not shown) in the server 2 (computer) on a CPU (not shown). These programs are prepared such that they are recorded on a computer-readable recording medium, such as a CD-ROM, a CDR, or a flexible disk.

The server 2 further includes a monitor unit 25, a transmission area management database 26, a client management database 27, and an advertising information database 28. The monitor unit 25, which, though not shown, comprises a display device and a data entry device such as a keyboard, is adapted to allow the server's manager to enter conditions for transmission of advertising information and manage them. The transmission area management database 26 stores the conditions for transmission of advertising information set up for each of transmission areas in association with the transmission area. The client management database 27 stores the count of passage through each of transmission areas and incentive information for each of clients 1. The advertising information database 28 stores advertising information to be transmitted for each of advertiser servers 6.

In the advertising information transmitting server 2, the transmission area management unit 21 stores the conditions for transmission of advertising information into the transmission area management database 26 in association with each of the transmission areas. The passage count update unit 22 receives position information from a client 1 which is passing through a transmission area, then determines the count of passage through the transmission area and stores it into the client management database 27. The advertising information transmission unit 23 transmits to that client advertising information dependent on its count of passage through that transmission area. The utilization unit 24, upon receipt of a request for confirmation of client identification information from the advertiser server 6, sends advertising information and incentive information assigned to the client 1 at that time to the advertiser server 6.

FIG. 3B shows the arrangement of the client 1 that receives advertising information.

The client 1 includes a position information notification unit 11, an advertising information receive unit 12, and a position information acquisition unit 13, which are implemented by executing programs resident in main storage (not shown) in the client computer on a CPU (not shown). These programs are prepared such that they are recorded on a computer-readable recording medium, such as a CD-ROM, a CDR, or a flexible disk.

In the client 1, the position information notification unit 11 sends the position information acquired by the position information acquisition unit 13 to the advertising information server 2. The advertising information receive unit 12 sends a request for confirmation of the passage count or incentive information to the advertising information transmitting server 2, then receives advertising information corresponding to the passage count from the server 2 and outputs it to the user. The position information acquisition unit 13 acquires client's position information sequentially and hence comprises a car navigation system. That is, in the client 1 running on the road 100, its position is detected by receiving signals from the GPS satellites 4 through an antenna 130 and then displayed on a map on a screen by means of the car navigation system 13.

As described previously, the client 1 is connected to a cellular phone 136 connectable to the Internet and makes communications with the advertiser server 6 or the terminal 61 (and the advertising information transmitting server 2) over the Internet (network 5).

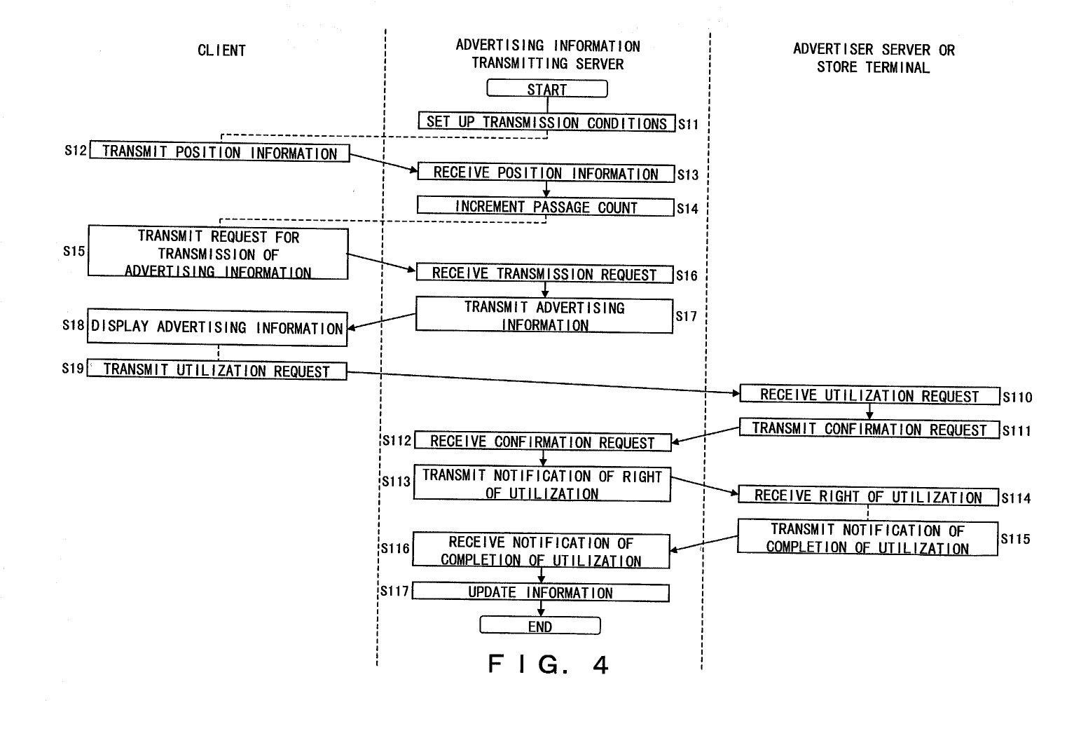

FIG. 4 is a flow diagram for the advertising information transmission processing carried out by the advertising information transmission system of the present invention. This process flow supposes that one advertiser server 6′ enters advertising information, the utilization of incentive information is made through the terminal 61 installed in the store 8, and the client 1 makes communications with the terminal 61 over the network 5 through the use of the cellular phone 136.

The advertising information transmitting server 2 sets up conditions for the transmission of advertising information in the transmission area management database 26 and enters the advertising information into the advertising information database 28 (step S11). The conditions for transmitting advertising information and the advertising information are entered from the advertiser server 6′.

The client 1 then transmits its position information to the advertising information transmitting server 2 sequentially (step S12). The advertising information transmitting server 2 receives the position information from the client 1 (step S13), then increments the count of passage through the transmission area 101 for the client 1 and determines incentive information according to the passage count (step S14).

The client 1 then transmits a request for transmission of advertising information to the advertising information transmitting server 2 (step S15). The server 2 receives the transmission request from the client 1 (step S16), then refers to the client management database 27 to determine the advertising information and incentive information for the client 1 and transmits the advertising information (including the incentive information) to the client 1 (step S17). The client 1 receives the advertising information and then displays it on the display screen associated with the car navigation system 13 (step S18).

The client 1 then transmits a request to utilize the incentive information to the terminal 61 (step S19). The terminal 61 receives that request from the client 1 (step S110). In response to reception of the request, the terminal 61 identifies the request transmitting client 1 and then transmits to the advertising information transmitting server 2 a request for confirmation of the incentive information (step S111). The server 2 then receives that request from the terminal 61 (step S112). The server 2 then notifies the terminal 61 of the client's right of utilization of the incentive information and the incentive information (step S113), so that the terminal receives a notification of the client's right of utilization and the incentive information (step S114).

The store 8 having the terminal 61 installed provides to the client 1 service according to the right of utilization and the incentive information. For example, when no incentive information is received, incentive service are unavailable. When incentive information is received, on the other hand, the client 1 is allowed to receive service indicated in the incentive information. For example, discount can be received.

The terminal 61 in the store 8 which provided the service to the client 1 then notifies the advertising information transmitting server 2 of the completion of utilization of the incentive information (service) (step S115). Upon receipt of the notification of completion of utilization of the incentive information (step S116), the advertising information transmitting server 2 updates the client's passage count and/or incentive information for the terminal 61 (step S117). That is, the passage count or the substance of the incentive information is reduced according to the utilization of the incentive information.

In this example, as described previously, in response to reception of a request made by the client 1 to transmit advertising information, the advertising information transmitting server 2 transmits advertising information according to the client's count of passage through the relevant transmission area at that time. However, the transmission of advertising information may be made when it is decided that the position of the client 1 is within the relevant area or when the client's count of passage through the area has reached a predetermined value.

Further, in this example, the client 1 first transmits a request for utilization of incentive information to the terminal 61 and, in response to reception of that request, the terminal then transmits a request for confirmation of the incentive information to the advertising information transmitting server 2. However, the utilization request and the confirmation request may be transmitted independently. For example, the client 1 transmits a request for utilization of incentive information to the advertising information transmitting server 2 and tells a clerk to that effect in the store having the advertiser server 6 or the terminal 61. After that, the advertiser server 6 or the terminal 61 transmits a request for confirmation of the incentive information to the advertising information transmitting server 2. In this case, after the reception of both the utilization request and the confirmation request for the same client the advertising information transmitting server 2 examines the client's right of utilization and incentive information and then notifies the advertiser server 6 or the terminal 61 of them.

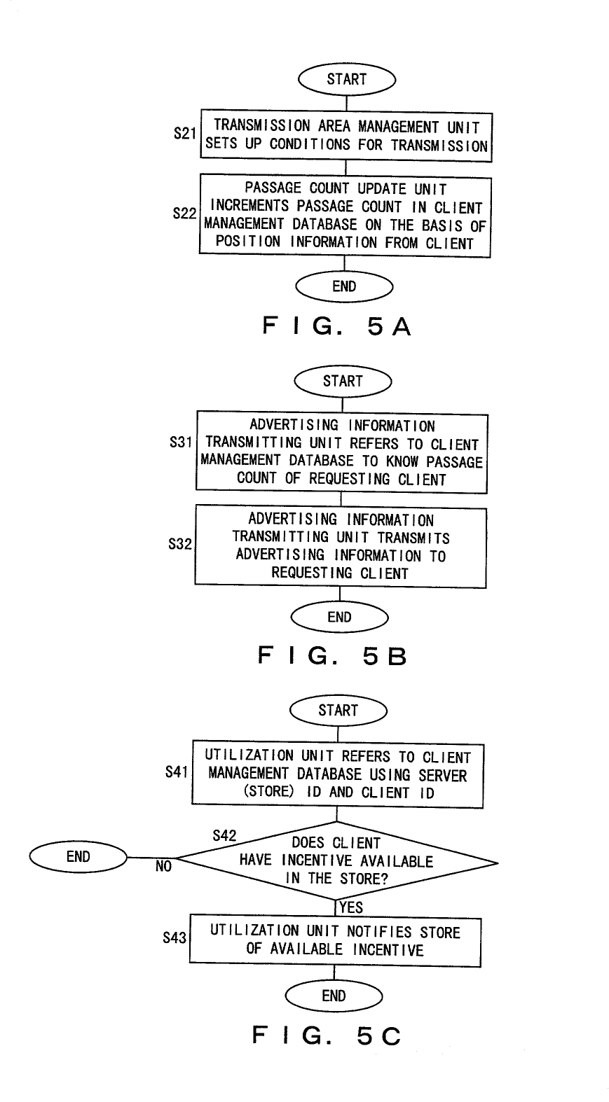

FIG. 5A shows a process flow for the processing of setting up the conditions for transmission of advertising information and updating the passage count carried out by the advertising information transmitting server 2 in the flow from steps S11 to S14 in FIG. 4.

The transmission area management unit 21 sets up conditions for transmission of advertising information in the transmission area management database 26 on the basis of data entry by the server manager through the monitor unit 25 and enters advertising information into the advertising information database 23 (step S21).

The passage count update unit 22 counts a passage of the client 1 through the transmission area 101 on the basis of position information (measured in terms of latitude and longitude) from the client 1 and increments the current passage count in the client management database 27 (step S22). That is, the passage count update unit 22, upon receiving the position information and client ID from the client 1, refers to the transmission area management database 26 to determine the transmission area through which the client 1 is passing, then refers to the client management database 27 using the client ID and increments the client's current count of passage through that transmission area by one. When transmission areas are overlapping, the passage through the overlapping portion is counted for each of the overlapping transmission areas.

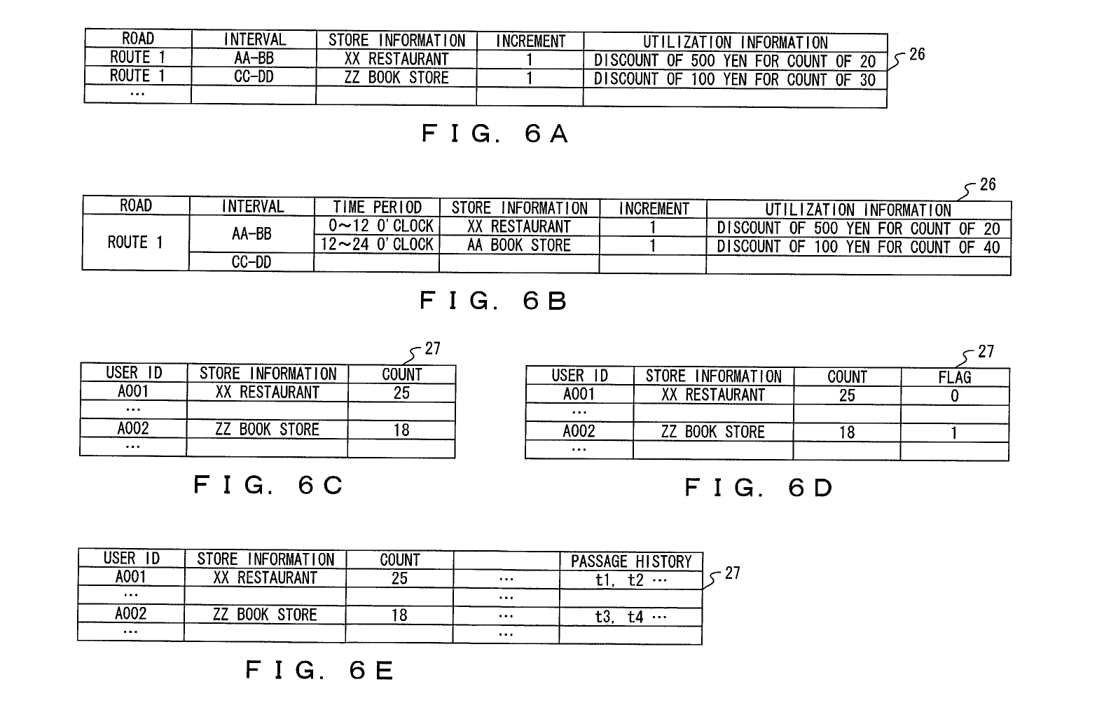

An example of the transmission area management database 26 is illustrated in FIG. 6A. The database 26 stores, for each transmission area, the name of each advertiser server (or the name of each advertising information or store), the count (or the point) per passage, and utilization (service) information. The transmission area, when determined by a route, comprises the road name and an interval. The passage count is incremented by one for each passage. The utilization information defines rules to provide incentive information indicating discount such that a discount of 500 yen is made for a passage count of 20. The incentive information includes presents of items or admission tickets (charged or free), invitation to events or travels (charged, free, or discount), etc. In general, as the passage count increases, the service increases in quality. Actually, the utilization information is set up according to the passage count (i.e., there are a plurality of pieces of utilization information). The utilization information is therefore held in a table not shown and referred to using the transmission area, the advertiser server name and the passage count (or points) as retrieval keys.

As an alternative to the passage count, points may be used which are given based on the passage count. The points given with each passage may be fixed or changed according to periods of time. With overlapping transmission areas, the points may vary for each of advertiser servers as will be described later.

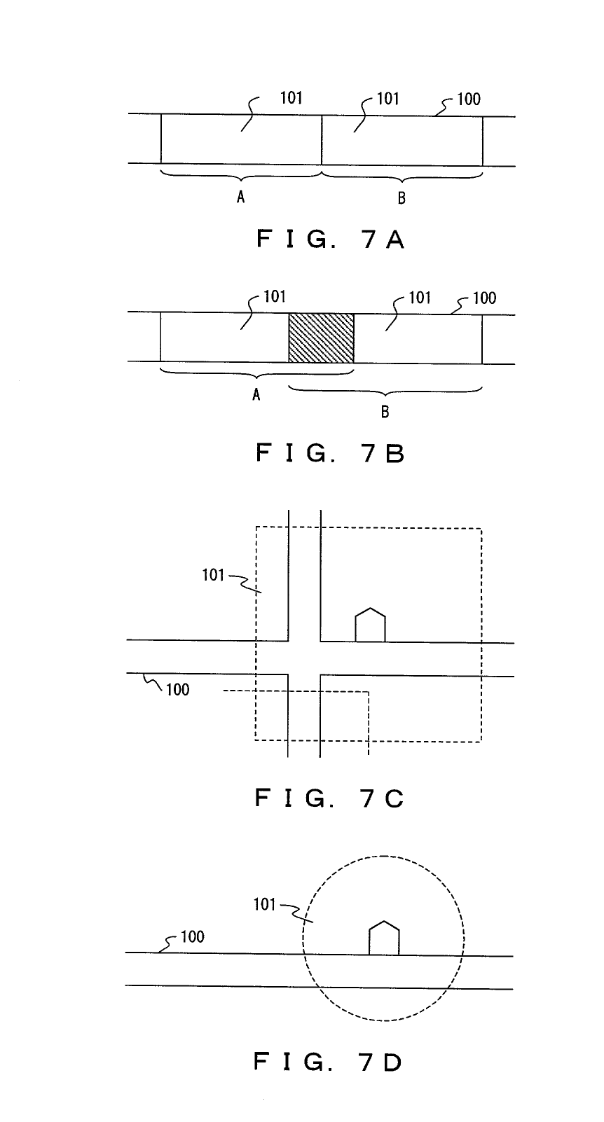

Adjacent transmission areas A and B are usually set up so that they do not overlap with each other as shown in FIG. 7A. Alternatively, the transmission areas A and B may be set up so that they have an overlapping portion as shown shaded in FIG. 7B. In these cases, the starting and ending points of each transmission area 101 is defined in latitude and longitude. The transmission area may be defined in terms of a plane. In this case, the transmission area 101 is made to have a square or rectangular shape with the advertiser server positioned in the center of gravity or a circle shape centered at the advertiser server. In the former case, the sides of the transmission area are defined in terms of latitude and longitude. In the latter case, the transmission area is defined in terms of center coordinates (latitude and longitude) and radius. The transmission area may also be of a polygonal shape. In any case, the transmission area may overlap with any other transmission area. In any case, the length of the route may be the same for transmission areas or variable. The same applies to the size of the transmission area.

When the transmission areas overlap, in the overlapping portion thereof the advertising information transmitting server 2 transmits to the client advertising information corresponding to the passage count in each of the overlapping transmission areas in accordance with predefined rules. For example, pieces of advertising information are transmitted in turn to the client 1 or are transmitted in turn at regular intervals. Alternatively, advertising information in a certain transmission area and advertising information in another transmission area are transmitted in the ratio of two to one. In this case, the advertising information in the former case is set higher in advertisement rate.

Here, as shown in FIG. 6B, the advertising information transmitting server 2 may divide the transmission area in time to thereby assign a plurality of different pieces of advertising information to be transmitted to the client 1 for time periods. In this case, therefore, the advertising information transmitting server 2 transmits to the client 1 the different pieces of advertising information according to the time periods. For example, in the morning and evening, advertising information for a convenience store the users of which are expected to increase in such time periods is transmitted. In the daytime, on the other hand, advertising information for a family restaurant is transmitted. Alternatively, different advertising information may be transmitted at an interval of one hour. In addition to the advertising information, the incentive information to be provided to the client 1 may also be set up for each time period.

The price of a contract for transmission of advertising information between the advertising information transmitting server 2 and the advertiser server 8 increases as the route or area increases in length or size. Independently of the size of a transmission area, the price may be set according to the vehicle traffic in the transmission area, transmission time periods (e.g., the evening when traffic is congested or the daytime when there are many shoppers), and the conditions of the transmission area (shopping quarters are located near by or there are many competing stores). As described previously, when transmission areas overlap with each other, discount may be made.

An example of the client management database 27 is illustrated in FIG. 6C. The database stores the name of the advertiser server (or the name of advertising information) and the passage count for each client ID. The passage count indicates the result of the addition by the passage count update unit 22 of a new count to the passage count set in the transmission area management database 26. The client ID is the number on the number plate of a motor vehicle (client). As an alternative, the client ID maybe the number of a credit card, the number of a cellular phone used as a communication unit, or some password.

The advertising information transmitting server 2, when told by a client 1 that the transmission of advertising information is unnecessary, may omit to transmit advertising information according to the passage count to the client 1. To this end, a flag is stored in the client management database for each client ID as shown in FIG. 6D. The flag, when set to zero, indicates that the client 1 desires the transmission of advertising information and, when set to one, indicates that the client 1 does not desire. Thus, the advertising information transmitting server 2 will not transmit advertising information to a client 1 for which the flag is set to one. In this case, the client 1 is not supplied with incentive information according to the passage count. For the client 1 for which the flag is set to one, the passage count may be counted or may not be counted.

When a client 1 passes through the same transmission area several times within a predetermined period of time, the advertising information transmitting server 2 may omit to increment the passage count for the second passage and later. In this case, therefore, the advertising information transmitting server 2 omits to transmit advertising information to the client 1.

To this end, as shown in FIG. 6E, the client management database stores the history of passage for each client ID. For example, times t1, t2 and so on at which the client 1 entered a transmission area are recorded in time sequence. The passage count is not incremented within a sufficient time to pass through the transmission area from the entry time. Advertising information is transmitted once at the time when the client 1 entered the transmission area and displayed for a given period of time (or within the sufficient time to pass through the transmission area). Even if the client 1 passes through the transmission area again (and again) within a predetermined period of time from the entry time, the passage count is not incremented. The predetermined period of time is set to range from 30 minutes to one hour. That is, if the time t2 when the client 1 entered the transmission area is within one hour from the immediately preceding time t1 recorded in the passage history, the passage count is not counted, nor is advertising information sent.

When a client 1 passes through the same transmission area several times within a predetermined period of time, different advertising information for the same advertiser server may be transmitted to the client 1 for each passage. In this case, a plurality of pieces of advertising information is prepared and each passage is counted.

FIG. 5B shows a process flow for the transmission of advertising information carried out by the advertising information transmitting server 2 in the flow from S15 to S18 in FIG. 4.

The advertising information transmitting unit 23 refers to the client management database 27 to know the passage count of the client 1 at that time (step S31). Upon receipt of the position information and a request for confirmation of the passage count from the client 1, the advertising information transmitting unit 23 refers to the transmission area management database 26 using the position information to determine a transmission area in which the client's position belongs and then refers to the client management database 27 using the client ID to know the passage count of the client 1 at that time.

The advertising information transmitting unit 23 retrieves advertising information to be transmitted from the advertising information database 28 on the basis of the position information and the passage count and then transmits it to the client 1 (step 32). The advertising information contains incentive information.

An example of the advertising information database 28 is illustrated in FIG. 28. The database stores advertising information 281, 282, . . . so that they are mapped into the names of advertiser servers (the names of the advertising information, illustrated at H). The advertising information for one advertising server, for example, the advertising information 281, is divided into different pieces 2811, 2812, 2813, . . . according to the passage count. When the passage count is as low as 0-10, the advertising information 2811 is transmitted which consists of the name of the advertiser server and information such as “right turn”, i.e., mere advertising information. When the passage count is in the medium range from 11 to 20, the advertising information 2812 comprises the name of the advertiser server and incentive information such as passage count. When the passage count is as high as 21-30, the advertising information 2813 comprises the name of the advertiser server and more incentive information such as discount. That is, the advertising information 2813 contains incentive information dependent on the passage count. The same applies to the other advertising information 282, The advertising information is not limited to character-based information. Image information and/or voice information may be used. To this end, a character file 2813-c storing character information, an image file 2813-i storing image information and a voice file 2813-v storing voice information are prepared for the advertising information 2813 by way of example. Also, the advertising information may be transmitted and received in the form of so-called electronic mail. According the form of receiving information in the client 1, the advertising information may be transmitted in the form of character, image, and/or voice. The same applies to the other advertising information 2811, 2812, . . . , 282, . . . .

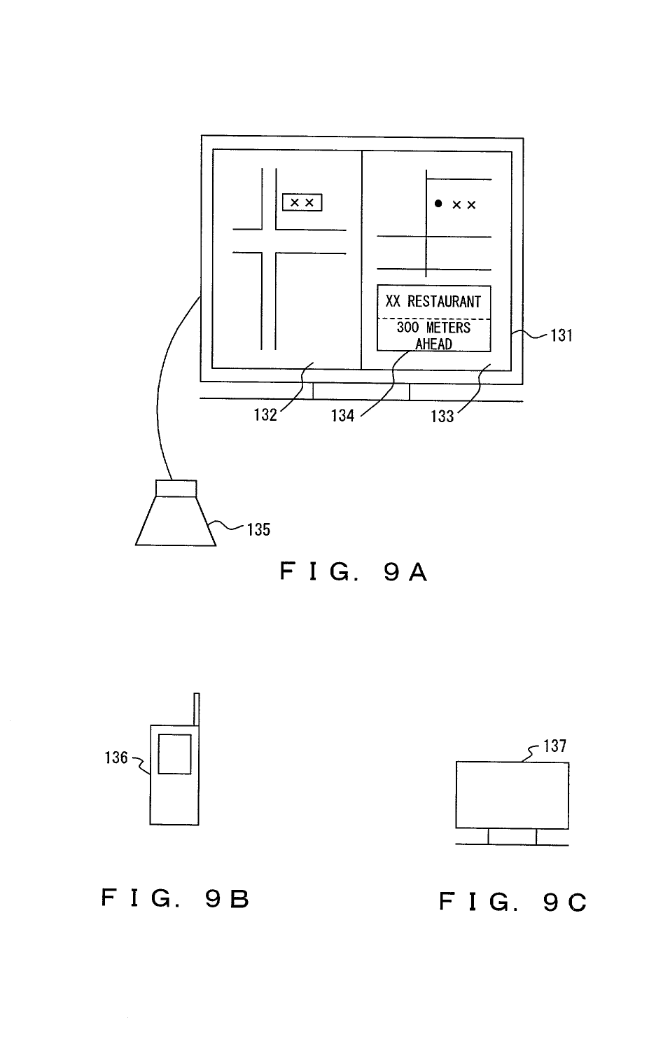

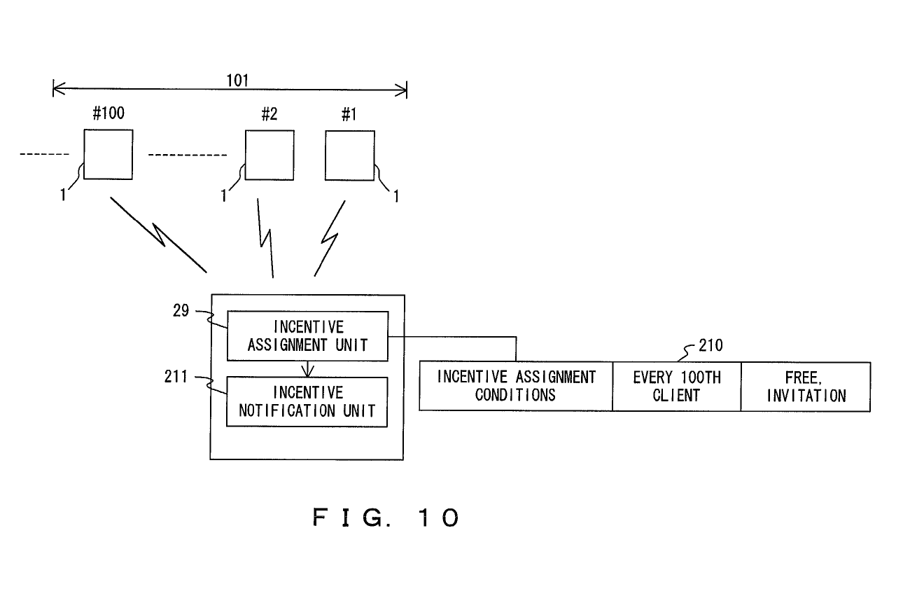

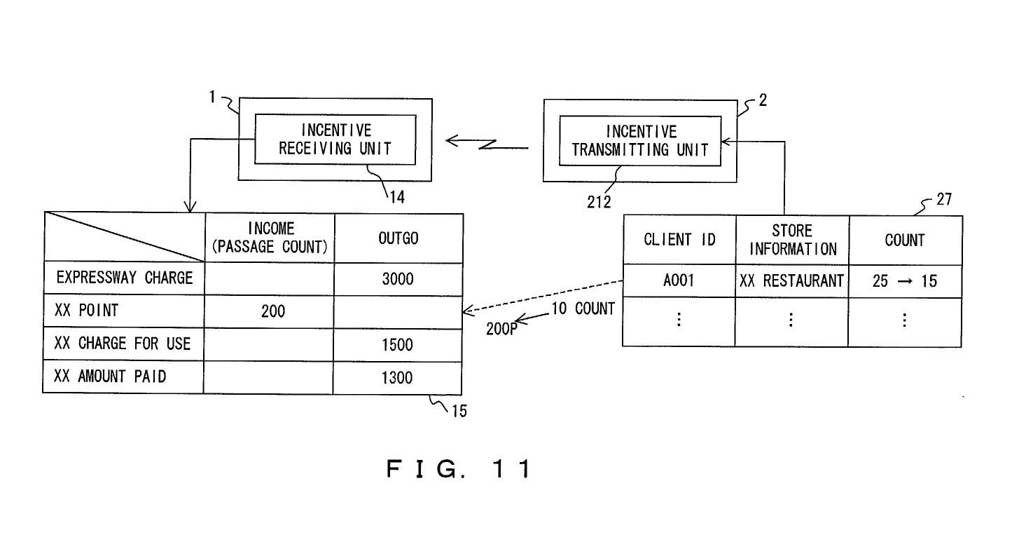

An example of a form of outputting advertising information is illustrated in FIGS. 9A, 9B and 9C.

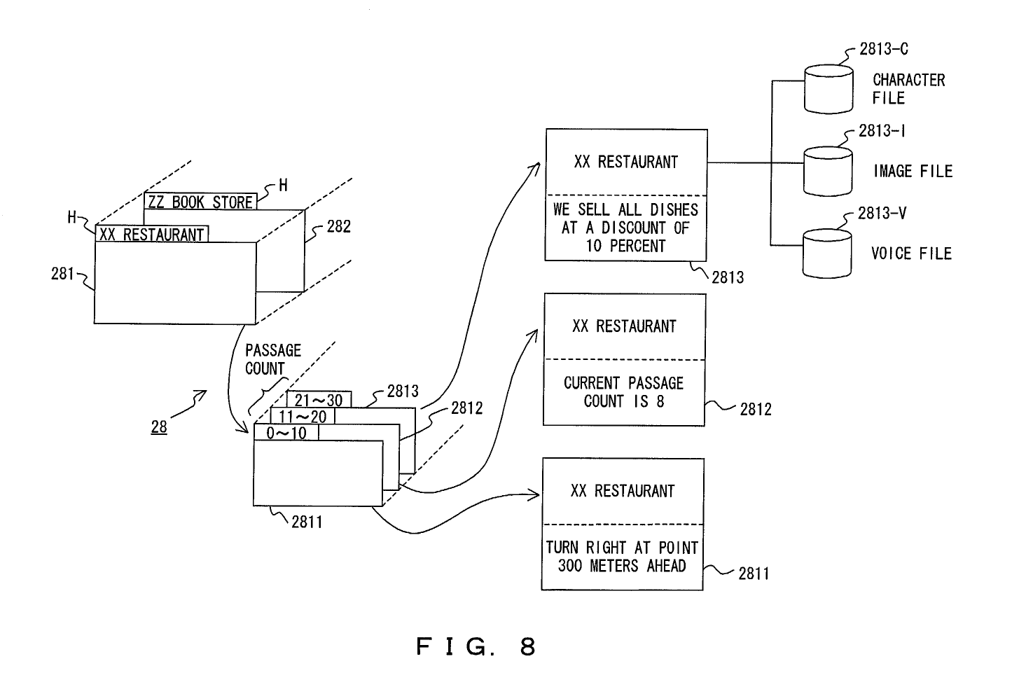

Advertising information is usually displayed superimposed on a portion of a display screen 131 of the car navigation system 13 as shown in FIG. 9A. For example, suppose that the display screen 131 is divided into two sections: one for an enlarged map 132 and one for a route map 133. Then, a pop-up window 134 for advertising information appears on a portion of the route map 133. The advertising information displayed in the pop-up window is that such as shown in FIG. 8. Thereby, the user of the client 1 will see a display of the store (XX restaurant) of the advertiser server on the enlarged map and its associated advertising information (and incentive information, if any) in the transmission area through which the client 1 is passing at that time.

It is dangerous for the driver to gaze at the display screen; thus, the advertising information may be audibly output through a speaker 135 associated with the car navigation system. If the driver uses a cellular phone 136, then the advertising information is displayed on its display screen as shown in FIG. 9B. Moreover, the driver may use a personal computer 137 installed in his or her house to make access to the advertising information transmitting server (Web server) over the Internet for his or her passage count (or the incentive information). In this case, as the client ID use can be made of a password used to gain access to the Internet.

FIG. 5C shows a process flow for the utilization of incentive information carried out by the advertising information transmitting server 2 in the flow from S19 and S110 to S113 in FIG. 4.

The utilization unit 24 refers to the client management database 27 to know the passage count of the client 1 at that time (step S41). That is, upon receipt of a utilization request from the client 1, and the server ID, the client ID and a confirmation request from the advertiser server, the utilization unit refers to the line management database 27 using the server ID and the client ID, then gains the passage count of the client 1 at that time for that advertiser server (and incentive information) and sends it to the advertiser server. In the absence of one of the utilization request from the client 1 and the confirmation request from the advertiser server, the client 1 is considered to have no incentive information (the utilization is not admitted). Alternatively, the utilization may be admitted with only one of the utilization request and the confirmation request.

The utilization unit 24 examines whether the client 1 has incentive information available in the advertiser server (step S42). If not, a notification to that effect is sent to the client 1 and the process ends; otherwise, the utilization unit transmits the passage count (and incentive information) to the advertiser server (step 43).

In the store having the advertiser server installed, the utilization of incentive information is made as follows: If the incentive information indicates that some service is free, the client driver receives the free service. If the incentive information indicates a discount sale, accounting is required. In this case, the client 1 makes a normal payment by a credit card for the accounting server 7. In a later day, the accounting server makes access to the advertising information transmitting server 2 to inquire about the incentive information for the client 1 (e.g., discount rate) and then makes an offset account according to the incentive information. That is, the account is made up in such a way that the price is reduced by the amount corresponding to the discount rate.

After the utilization of the incentive information, the incentive information is offset by utilization thereof. That is, on the basis of a notification of completion of utilization from the advertiser server, the advertising information transmitting server cancels the incentive information for the client 1 in the transmission area and resets the passage count to zero. Or, as shown in FIG. 6, when the utilization information in the transmission area management database describes a discount of 500 yen for a passage count of 20, the advertising information transmitting server reduces the passage count by the count (20) indicated in the incentive information after the receipt of a notification of the utilization of the discount service.

In the foregoing, passage count dependent incentive information is given to clients 1 together with associated advertising information. Alternatively, incentive information distinct from advertising information may be given to clients 1 that meet specific conditions.

To this end, the advertising information transmitting server 2 includes an incentive assignment unit 29, an incentive assignment condition file 210, and an incentive notification unit 211. The advertising information transmitting server 2 sets up in the incentive assignment condition file 210 conditions for assigning incentive information distinct from advertising information to clients 1 in a predetermined advertising information transmission area. The advertising information transmitting server 2 receives the position information from a number of clients 1 (#1-#100 . . . ) through the incentive assignment unit 29, then determines the state of passage of each client 1 in a transmission area 101 in which the position information belongs and assigns the incentive information to a client 1 that meet the conditions. The advertising information transmitting server 2 notifies the client 1 (#100) of assignment of the incentive information through the incentive notification unit 211.

For example, every hundredth client 1 in the transmission area 101 is assigned the incentive information of “free invitation . . . ”. The incentive information may be such that a drink of tea or coffee is provided free in our shop. The incentive information may be assigned to a client that passed a certain point (e.g., the point 300 meters ahead of the store) at a certain time (e.g., at noon). Although the specific client 1 is notified of the assignment of incentive information, it is desirable to previously notify clients 1 that such incentive information can be assigned. The time of advance notification includes the time of purchase of vehicles, the time of purchase of car navigation systems, the time of contract with the advertising information transmitting server, the time of applying for membership, etc.

In the foregoing, the passage count and incentive information of each client 1 are managed by the advertising information transmitting server. A client 1 may be adapted to manage its own passage count and incentive information.

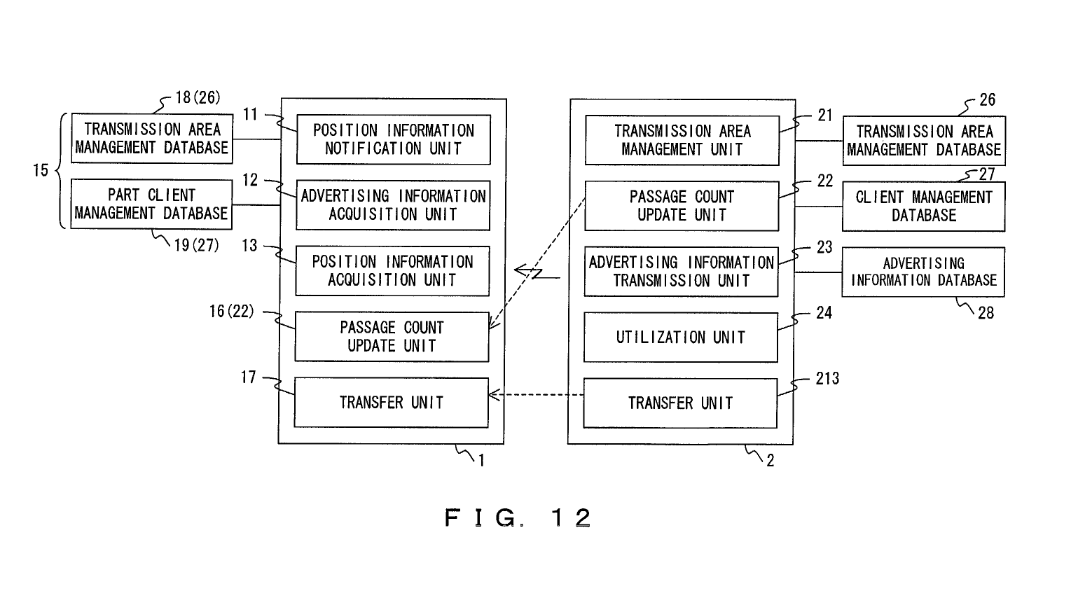

To this end, as shown in FIG. 12, the client 1 includes an incentive receiving unit 14 and the advertising information transmitting server 2 includes an incentive transmitting unit 212. The client 1 transmits a request for transfer of passage count or incentive information to the advertising information transmitting server 2 via the incentive receiving unit 14 and stores the passage count or incentive information from the server 2 on a portable external storage medium 15, which may be a smart card. Upon receipt of a request for transfer, the advertising information transmitting server 2 transmits the passage count of the client 1 in the transmission area at the time of reception of the request or corresponding incentive information to the client 1.

The incentive transmitting unit 212 subtracts the transferred passage count or incentive information from the passage count or incentive information of the client 1 in the client management database 27. In the transfer request, the passage count or incentive information may be specified by the client 1. Even after the transfer, the passage count is accumulated whenever the client 1 passes through the transmission area.

The external storage medium 15 is used like electronic money so that drivers can receive various services in integrated form. The passage count or incentive information is written onto the storage medium in terms of points as a common measure. One point is taken as one yen. For example, suppose that a passage count of ten is transferred and this corresponds to 200 yen. Then, 200 points are written as electronic money for the XX restaurant. For example, for a meal of 1500 yen in the XX restaurant, the user is allowed to pay 1300 yen by the storage medium 15 (electronic money) or in cash and 200 yen by the points.

In this example, only the passage count or incentive information is transferred to the client 1. The updating itself of passage count (i.e., the client management database 27) may be transferred to the client 1.

To this end, as shown in FIG. 12, the client 1 includes a transfer unit 17 and the advertising information transmitting server 2 includes a transfer unit 213. The client 1 makes a request through the transfer unit 17 to the advertising information transmitting server 2 to transmit the transmission area management database 26. In response to this, the advertising information transmitting server 2 transmits the database 26 to the client 1 through the transfer unit 213. The client 1 receives the database 26 and makes it a transmission area management database 18 and creates a part client management database 19 which is associated with only its own part in the client management database 27.

The client 1 includes a passage count update unit 16 to update the passage count in the part client management database 19 according to the transmission area management database 18. The passage count update unit 16 is identical in function to the passage count update unit 22 in the server 2. The passage count update unit 16 is obtained by receiving a program of the passage count update unit 22 from the server 2. The transmission of the passage count update unit 22 can be carried out in the same manner as with the transmission area management database 26. The program of the passage count update unit 16 may be stored on the above-described external storage medium 15 or other storage medium and read into the client 1.

The client 1 obtains the passage count in a transmission area in which its own position information belongs through the passage count update unit 16 and stores it in the part client management database 19. The client 1 then transmits a request for transmission of advertising information and the passage count to the server 2 and receives advertising information according to the passage count in that transmission area. This advertising information contains incentive information as described previously. The transmission area management database 18 and the part client management database 19 are stored on the external storage medium 15. Thereby, various services for drivers can be integrated.

As described so far, according to the advertising information transmitting method of the present invention, when a client is passing through a transmission area, advertising information for a store in the transmission area can be transmitted to the client according to its passage count in that area, which helps in attracting customers. Furthermore, more profitable advertising information or incentive information can be transmitted to clients with more passage count, which is useful in drawing customers.

Moreover, incentive information distinct from (i.e., independent of the passage count) advertising information can be transmitted to clients according to predetermined conditions, thus, allowing even clients with relatively little passage count to be attracted as customers.

According to the present invention, each client can receive advertising information according to its passage count in a transmission area, allowing each client to receive more profitable advertising information or incentive information in a transmission area where its passage count is high.

What is claimed is:

1. A method transmitting advertising information, comprising:
receiving position information from a client;
determining a passage count of the client in a predetermined advertising information transmission area in which the position information belongs and storing the passage count; and
transmitting to the client advertising information according to the passage count of the client in the transmission area.

2. The method according to claim 1, wherein the advertising information according to the passage count of the client in the transmission area is transmitted to the client in response to reception from the client of a request to transmit advertising information.

3. The method according to claim 1, wherein the advertising information is transmitted in the passage count of the client has reached a predetermined value.

4. The method according to claim 1, wherein neighboring transmission areas are set up to overlap each other, and, in the overlapping portion of the transmission areas, advertising information according to the passage count of the client in each of the overlapping transmission areas is transmitted in accordance with predetermined rules.

5. The method according to claim 1, wherein the advertising information includes incentive information assigned to the client according to the passage count.

6. The method according to claim 1, wherein, when the client passes through the same transmission area two or more times within a predetermined period of time, the second passage and later are not counted.

7. The method according to claim 6, wherein, when the client passes through the same transmission area two or more times within a predetermined period of time, the transmission of the advertising information according to the second passage and later to the client is omitted.

8. The method according to claim 1, wherein the transmission of advertising information to the client is omitted as instructed by the client.

9. The method according to claim 1, wherein the transmission area is divided in transmission time periods, and a different piece of advertising information to be transmitted to the client in the transmission area is registered for each transmission time period.

10. The method according to claim 9, wherein different pieces of advertising information according to the transmission area and the transmission time periods are transmitted to the client.

11. The method according to claim 10, wherein when the client is passing through the transmission area, advertising information according to the passage count in the corresponding the transmission time period is transmitted to the client.

12. A computer-readable program recording medium recorded with an advertising information transmitting program which causes a computer to execute the processing, comprising:
receiving position information from a client;
determining a passage count of the client in a predetermined advertising information transmission area in which the position information belongs and storing the passage count; and
transmitting to the client advertising information according to the passage count of the client in the transmission area.

13. A method transmitting advertising information, comprising:
setting up conditions assigning incentive information distinct from the advertising information in a predetermined advertising information transmission area;
receiving position information from a number of clients;
determining the state of passage of each of the clients in the transmission area in which the position information from the clients belong; and
assigning the incentive information to the client or clients that meet the conditions on the basis of the state of passage.

14. A method receiving advertising information, comprising:
transmitting position information of a client sequentially to a server;
receiving from the server advertising information according to the count of passage through that transmission area at that time, when passing through an advertising information transmission area in which the position information belongs.

15. A computer-readable program recording medium recorded with an advertising information receiving program which causes a computer to execute the processing, comprising:
transmitting position information of a client sequentially to a server;
receiving from the server advertising information according to the count of passage through that transmission area at that time, when passing through an advertising information transmission area in which the position information belongs.

16. A method receiving advertising information, comprising:
transmitting position information of a client sequentially to a server;
transmitting a request for transfer to the server;
receiving the count of passage through a transmission area for the advertising information at the time of transmission of the transfer request or corresponding incentive information to the passage count; and
storing the received passage count or incentive information on a portable external storage medium.

17. A method receiving advertising information, comprising:
receiving a transmission area management database which defines transmission areas for advertising information;
retrieving from the database a count of passage through the transmission area through which it is passing based on position information of a client, and storing the count of passage;
transmitting to the server a request for transmission of advertising information and the passage count; and
receiving from the server advertising information according to the passage count in the transmission area at time of the transmitting.
